(19) United States
(12) Patent Application Publication
(10) Pub. No.: US 2026/0036421 A1
(43) Pub. Date: Feb. 5, 2026

(54) DETERMINATION OF SUBSTRATE SUPPORT PROPERTIES USING A DISTANCE SENSOR

(71) Applicant: Applied Materials, Inc., Santa Clara, CA (US)

(72) Inventors: Mauro Cimino, San Jose, CA (US); Paul Z. Wirth, Kalispell, MT (US)

(21) Appl. No.: 18/792,856

(22) Filed: Aug. 2, 2024

(51) Int. Cl. G01B 11/30

(52) U.S. Cl. CPC G01B 11/303

(57) ABSTRACT

One or more distance sensors disposed above a substrate support generate distance measurements between the substrate support and the one or more distance sensors. A processing device determines at least one of (i.) one or more first metric values indicative of one or more surface properties of the substrate support based on the distance measurements, or (ii.) one or more second metric values indicative of one or more alignment properties associated with the substrate support based on the distance measurements. The processing device causes one or more of (a.) at least one of the one or more first metric values or at least one of the one or more second metric values to be output for display on a GUI, or (b.) performance of a corrective action associated with the substrate support based on the one or more first metric values or the one or more second metric values.

### TECHNICAL FIELD

Embodiments of the present disclosure generally relate to the determination of substrate support properties using a distance sensor, and more specifically relate to systems and methods for determining substrate support properties.

### BACKGROUND

A substrate processing chamber may include one or more substrate supports for holding a substrate during processing. The build quality and surface finish of the substrate support(s) is assessed prior to processing substrates in the chamber. Various properties of the substrate support(s) may be assessed.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

Some of the embodiments described herein are directed to a method. The method includes generating a first plurality of distance measurements of first distances between a substrate support and one or more distance sensors disposed above the substrate support. The method further includes determining, by a processing device, at least one of (i.) one or more first metric values indicative of one or more surface properties of the substrate support based on the first plurality of distance measurements, or (ii.) one or more second metric values indicative of one or more alignment properties associated with the substrate support based on the first plurality of distance measurements. The method further includes causing, by the processing device, one or more of (a.) at least one of the one or more first metric values or at least one of the one or more second metric values to be output for display on a graphical user interface (GUI), or (b.) performance of a corrective action associated with the substrate support based on at least one of the one or more first metric values or at least one of the one or more second metric values.

Additional or related embodiments described herein are directed to a non-transitory machine-readable storage medium. The non-transitory machine-readable storage medium includes instructions that, when executed by a processing device, cause the processing device to perform operations. The operations include causing one or more distance sensors disposed above a substrate support to generate a first plurality of distance measurements of first distances between the substrate support and the distance sensor. The operations further include determining at least one of (i.) one or more first metric values indicative of one or more surface properties of the substrate support based on the first plurality of distance measurements, or (ii.) one or more second metric values indicative of one or more alignment properties associated with the substrate support based on the first plurality of distance measurements. The operations further include causing one or more of at least one of the one or more first metric values or at least one of the one or more second metric values to be output for display on a graphical user interface (GUI), or (b.) performance of a corrective action associated with the substrate support based on at least one of the one or more first metric values or at least one of the one or more second metric values.

Further embodiments described herein are directed to a system. The system includes a sensor fixture configured to couple to a substrate processing chamber. The system further includes one or more distance sensors coupled to the sensor fixture and configured to generate a first plurality of distance measurements of first distances between a substrate support disposed within the substrate processing chamber and the distance sensor. The system further includes a processing device operatively coupled to the one or more distance sensors. The processing device is configured to determine at least one of (i.) one or more first metric values indicative of one or more surface properties of the substrate support based on the first plurality of distance measurements, or (ii.) one or more second metric values indicative of one or more alignment properties associated with the substrate support based on the first plurality of distance measurements. The processing device is further configured to cause one or more of (a.) at least one of the one or more first metric values or at least one of the one or more second metric values to be output for display on a graphical user interface (GUI), or (b.) performance of a corrective action associated with the substrate support based on at least one of the one or more first metric values or at least one of the one or more second metric values.

Numerous other features are provided in accordance with these and other aspects of the disclosure. Other features and aspects of the present disclosure will become more fully apparent from the following detailed description, the claims, and the accompanying drawings.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates a simplified representation of a system for determining substrate support properties, according to aspects of the present disclosure.

FIG. 2 depicts a sectional view of one embodiment of a processing chamber, according to aspects of the present disclosure.

FIG. 3 depicts an illustrative computer system architecture, according to aspects of the present disclosure.

FIG. 4 illustrates various substrate support assembly alignment properties, according to aspects of the present disclosure.

FIG. 5 is a flow chart of a method for determining substrate support properties, according to aspects of the present disclosure.

FIGS. 6A-6B are flow charts of methods for collecting data associated with a substrate support, according to aspects of the present disclosure.

FIGS. 7A-7B are flow charts of methods for determining substrate support properties, according to aspects of the present disclosure.

FIG. 8 depicts a diagrammatic representation of a computing device, according to aspects of the present disclosure.

### DETAILED DESCRIPTION OF EMBODIMENTS

Embodiments of the present disclosure are directed to systems and methods for determining substrate support properties using a distance sensor. Process results of manufacturing processes depend on many factors, including process recipes, and chamber component conditions. For example, process results may vary across the surface of a substrate based on the surface finish of a substrate support and/or the alignment of the substrate support. The surface finish and/or alignment of a substrate support can have a direct impact on the quality of processing performed on substrates. Thus, it can be useful to determine metrics indicative of the surface properties and/or alignment properties of a substrate support before the associated processing chamber is used for substrate processing.

In a typical processing chamber, the top surface of a substrate support is flat and horizontal by design. Additionally, the top surface is to have a specific surface finish or surface roughness. However, the substrate support may be manufactured and/or assembled so that its top surface is not flat, is not horizontal, and/or so that its surface finish does not meet specifications. Such defects may have direct impacts on substrate processing. For example, a substrate support may have misalignment of the center of the substrate support relative to a showerhead and/or a processing chamber. Such a misalignment can be a sign that precursors, process gases, etc. may also not be flowed or delivered within the chamber where expected. As another example, defects in the surface finish of the top surface of the substrate support (e.g., such as waviness and/or roughness) can cause the substrate support to interfere with other components within the processing chamber, which in turn can cause the generation of unwanted particles within the chamber and/or damage to the components. In another example, inclination of the axis-of-rotation of the substrate support (e.g., for rotatable substrate supports) can lead to uneven processing of substrates and can further lead to undue wear and tear of the components used to rotate the substrate support. In a further example, inclination of the substrate support indicates a load imbalance on the substrate support and may prevent the substrate support from reaching a target position within the processing chamber, and moreover may lead to inconsistent substrate processing. A method for determining the above properties of a substrate support can be advantageous, such as for determining whether the associated processing chamber should be used for substrate processing, etc.

Aspects and implementations of the instant disclosure provide a method for determining substrate support properties using a distance sensor. In some embodiments, one or more distance sensors coupled to a sensor fixture (e.g., a calibration bar) are used to measure the properties of a substrate support in a substrate processing chamber. The lid (e.g., showerhead, etc.) of the processing chamber may be removed, exposing the interior of the chamber. The sensor fixture may be coupled to the chamber in place of the lid. In some embodiments, the one or more sensors are used to generate measurements of the distance between the top surface of the substrate support and the one or more sensors. Measurements may be generated for multiple locations on the top surface of the substrate support. In some embodiments, the substrate support is caused to rotate beneath the sensor fixture so that sensor measurements can be taken at multiple locations on the substrate support. In some embodiments, the sensors can move relative to the sensor fixture and/or relative to the substrate support so that sensor measurements can be taken at multiple locations on the substrate support.

In some embodiments, a processing device is operatively coupled with the one or more distance sensors. The processing device receives sensor data (e.g., from the one or more distance sensors) indicative of the distance measurements. In some embodiments, the processing device determines metrics indicative of surface properties of the substrate support based on the distance measurements. For example, and in some embodiments, the processing device determines a surface roughness and/or a surface flatness of the substrate support, using the distance measurements. The processing device may determine one or more metric values (e.g., unitless metric values) that quantify the surface roughness and/or the surface flatness of the substrate support. For example, and in some embodiments, the processing device determines a first metric value indicative of the surface roughness and a second metric value indictive of the surface flatness.

In some embodiments, the processing device determines metrics indicative of alignment properties associated with the substrate support based on the distance measurements. For example, and in some embodiments, the processing device determines an orientation of an axis of the substrate support relative to an axis of a support shaft associated with the substrate support. In another example, and in some embodiments, the processing device determines an inclination of the support shaft axis relative to an axis of an inertial reference frame. In a further example, and in some embodiments, the processing device determines an orientation of an axis associated with one of the one or more distance sensors relative to the substrate support axis. In another example, and in some embodiments, the processing device determines a misalignment of the inertial reference frame axis relative to a center of the substrate support. The processing device may determine one or more metric values (e.g., unitless metric values) that quantify the above measures.

Based on the determined metrics, the processing device may cause performance of a corrective action associated with the substrate support. For example, and in some embodiments, the processing device may output an indication that the substrate support is misaligned and/or that the substrate support has an undesirable surface finish. The processing device may output at least one of the metric values for display on a graphical user interface (GUI). A technician or engineer, etc. may view the metric values and may make a determination associated with the substrate processing chamber and/or the substrate support based on the metric value(s). For example, a technician may decide to adjust, repair, rebuild, etc. the substrate support upon viewing a metric value indicating the substrate support is not properly aligned, etc. Additionally, or alternatively, processing logic may assess the determined metric values, and may compare the one or more determined metric values to one or more rules or criteria. If the determined metric values violate one or more criteria, processing logic may output a recommendation to replace the substrate support and/or to perform maintenance on the substrate support. In some embodiments, processing logic may automatically schedule maintenance of the substrate support responsive to determining that such maintenance is warranted.

Embodiments of the present disclosure provide advantages, such as determination of substrate support surface properties and alignment properties. By determining properties associated with the surface finish and/or alignment of a substrate support, the consistency of substrate processing can be improved. For example, it can be determined whether to perform maintenance on a substrate support or whether to rebuild or replace a substrate support before initiating substrate processing using the associated processing chamber. By repairing, rebuilding, or replacing the substrate support based on the metric values determined according to embodiments described herein, substrates can be processed with a heightened degree of consistency and with less scrap. Characterizing substrate support properties using metric values based on distance measurements may give technicians and/or engineers an accurate view of the state of the substrate support and/or of the substrate processing chamber. Such a view can allow technicians and/or engineers to adjust substrate processing procedures (e.g., recipes, etc.) to account for the substrate support properties. Again, this can lead to increased processing consistency, with more substrate meeting a target recipe specification and less scrap. Therefore, overall system throughput can be improved.

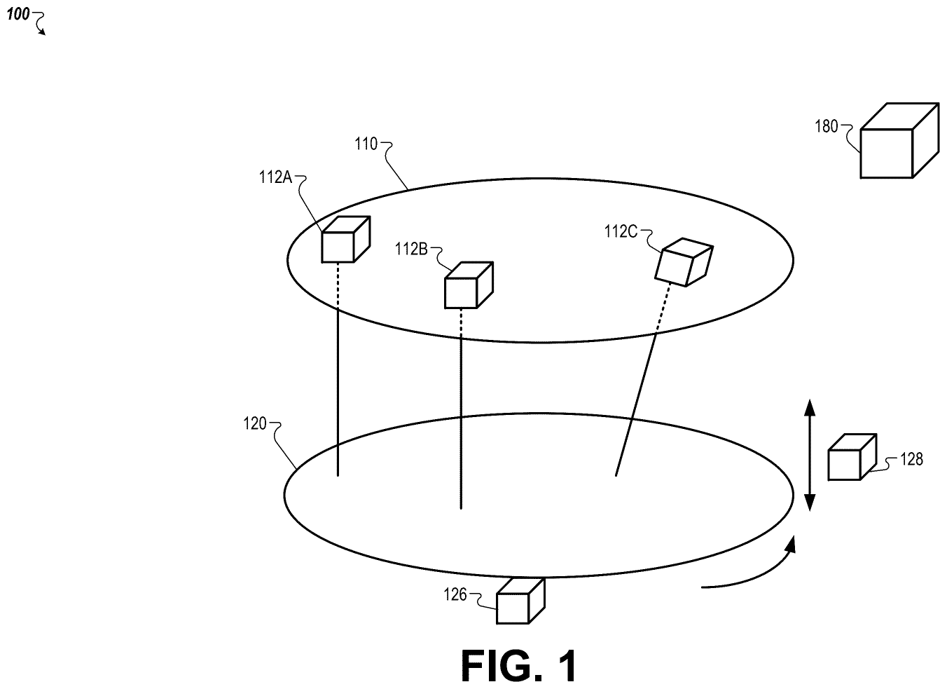

FIG. 1 illustrates a simplified representation of a system 100 for determining substrate support properties, according to aspects of the present disclosure. In some embodiments, a sensor fixture 110 includes one or more distance sensors 112. For example, and in some embodiments, sensor fixture 110 includes distance sensors 112A-C. The sensor fixture 110 may be coupled to a substrate processing chamber. The lid of the substrate processing chamber can be removed and the sensor fixture 110 may be coupled to the processing chamber in place of the lid. A substrate support 120 may be disposed within the processing chamber. In some embodiments, the distance sensors are laser-based distance sensors (e.g., LiDAR sensors). In some embodiments, the distance sensors are infrared distance sensors, which may emit infrared light to detect objects and measure distance. Other types of distance sensors that may be used include ultrasonic distance sensors, laser time-of-flight (ToF) sensors, optical distance sensors, magnetic distance sensors, and radar distance sensors. In some embodiments, when the sensor fixture 110 is coupled to the substrate processing chamber (e.g., in place of the chamber lid, etc.), the distance sensors 112 can emit beams (e.g., laser beams, etc.) downwards toward the top surface of the substrate support 120. At least a portion of the beams may be reflected off of the top surface of the substrate support 120 back towards the corresponding distance sensor 112. For example, an emitter of the distance sensor 112B may emit a beam downwards toward the surface of the substrate support 120. At least a portion of the beam may be reflected off of the surface back toward the sensor 112B. A receiver of the distance sensor 112B may receive the reflected portion of the beam. The receiver may be collocated with an emitted of the distance sensor, or may be positioned at a different location than the emitter of the distance sensor. The distance sensors 112 may use triangulation and/or time derivatives to generate distance measurements of the distance between the sensors 112 and the top surface of the substrate support 120 in some embodiments.

The distance sensors 112 may be coupled to the sensor fixture 110. In some embodiments, the sensors 112 are fixed to the sensor fixture 110 (e.g., by one or more mechanical fasteners, etc.). In some embodiments, the sensors 112 are coupled to the sensor fixture 110 so that the sensors 112 can move relative to the sensor fixture 110. For example, distance sensor 112A may be coupled to a track on the sensor fixture 110 so that the sensor 112A can move. In an example, a track may enable one or more sensors to move radially relative to a substrate support and measure distances at multiple different distances from a center of the substrate support. Movement of the distance sensor may allow for the sensor to generate more distance measurements than if the distance sensor were fixed in place. In embodiments where a distance sensor 112 is movable with respect to the sensor fixture 110, a position sensor may generate position measurements indicative of one or more positions of the distance sensor.

The beams emitted by the distance sensors 112 may be emitted substantially downward toward the top surface of the substrate support 120. In some embodiments, the beams may be substantially orthogonal to the sensor fixture 110. However, in some embodiments, the beams may not be orthogonal to the sensor fixture 110. For example, and in some embodiments, a distance sensor 112C may be tilted with respect to the sensor fixture 110 so that the emitted beam is nonorthogonal to the sensor fixture 110. At least a portion of the nonorthogonal may nevertheless be reflected from the top surface of the substrate support 120 back toward the sensor 112C.

The substrate support 120 may rotate (e.g., may be caused to rotate) while the distance measurements are generated. The substrate support 120 may be rotated while the distance sensors 112 emit beams toward the substrate support 120 to generate distance measurements for a plurality of locations on the top surface of the substrate support 120 (e.g., a plurality of locations at around a same distance from a center of the substrate support). Because the beams emitted by the sensors 112 can be used to measure one point at a time, the substrate support 120 is rotated to generate a plurality of point measurements. The plurality of measurements may be used to form one or more aggregate distance measurements and/or a distance measurement map for a surface of a substrate support, etc. In some embodiments, the angular orientation (e.g., rotational setting) of the substrate support 120 is measured by an angular orientation sensor 126. The sensor 126 may generate a plurality of orientation measurements of one or more angular orientations of the substrate support 120. In some embodiments, the sensor 126 is an encoder (e.g., an optical encoder) coupled to a motor (not illustrated) and/or to a rotatable shaft that causes rotation of the substrate support 120. A rotational or angular setting of the substrate support may be used to determine a location on the substrate support at which a measurement is generated.

The vertical position of the substrate support 120 may be changed during the generation of distance measurements. In some embodiments, a first set of distance measurements are generated while the substrate support 120 is at a first height and a second set of distance measurements are generated while the substrate support 120 is at a second height different from the first height. The second height may be higher or lower than the first height. In some embodiments, the first height and/or the second height may be predetermined. A height sensor 128 may measure the vertical position of the substrate support 120.

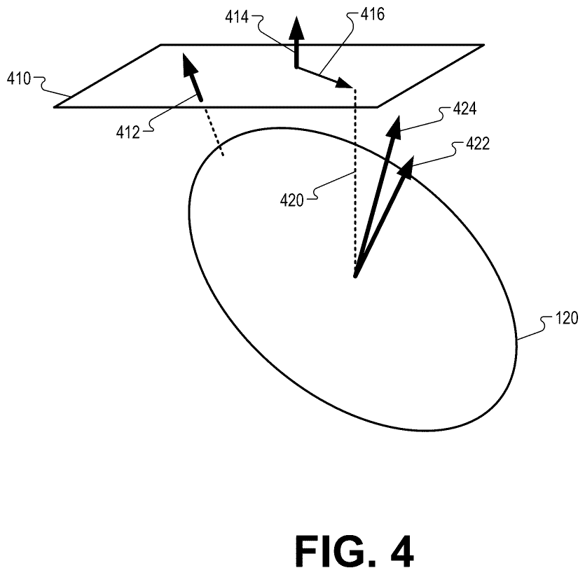

The distance measurements, in the form of sensor data, may be provided to a controller 180. Sensor data may be received by the controller from the distance sensors 112, the angular orientation sensor 126, and/or the height sensor 128. In some embodiments, the controller 180 uses the provided distance measurements, orientation measurements, and/or height measurements (e.g., sensor data, etc.) to determine one or more properties of the substrate support 120. For example, the controller 180 may determine alignment properties associated with the substrate support 120 and/or surface properties of the substrate support 120. The surface properties may include surface roughness and/or surface flatness. “Surface roughness” may refer to small, finely spaced deviations from the nominal surface that are inherent in the process of creating a surface. Surface roughness may be a measure of the texture of the surface. “Surface flatness” may refer to the degree to which a surface conforms to a perfectly flat plane. Surface flatness may be a measure of how much the surface deviates from being perfectly flat. Substrate support surface angle (e.g., angle of the shaft supporting the substrate support) relative to horizontal may also be determined. Alignment properties determined by the controller are described herein below with respect to FIG. 4. In some embodiments, the controller 180 determines metric values to quantify the substrate support properties. In some embodiments, the metric values are output by the controller 180 for display on a GUI. In some embodiments, the controller 180 performs a corrective action based on the metric values. For example, the controller 180 may provide an indication that the substrate support 120 has properties that do not meet a threshold value, etc. In another example, the controller 180 may provide an indication that the substrate support 120 is to be removed, replaced, repaired, and/or rebuilt, etc.

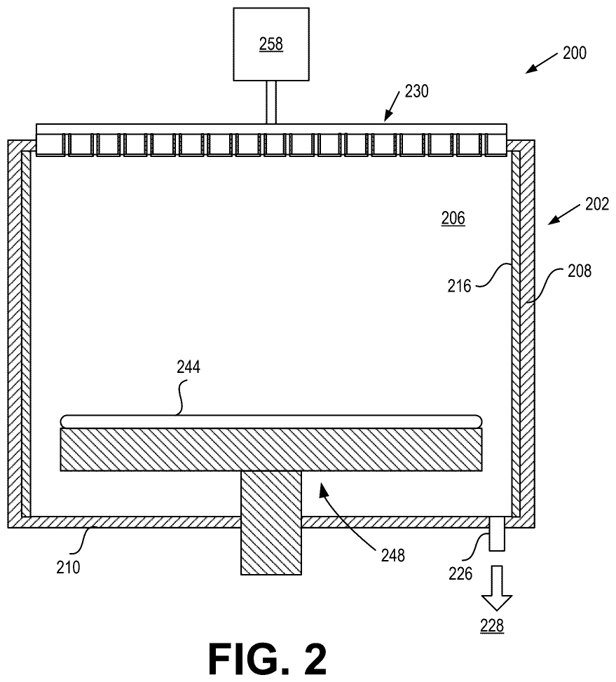

FIG. 2 is a sectional view of a processing chamber 200 (e.g., a semiconductor processing chamber, display processing chamber, etc.), according to aspects of the present disclosure. The processing chamber 200 may be used, for example, for processes in which a corrosive plasma environment having plasma processing conditions is provided. For example, the processing chamber 200 may be a chamber for a plasma etcher or plasma etch reactor, a plasma cleaner, and so forth. Other types of chambers may include deposition chambers, clean chambers, oxidation chambers, and so on. Examples of chamber components include a substrate support assembly 248, an electrostatic chuck (ESC), a ring (e.g., a process kit ring or single ring), a chamber wall, a base, a gas distribution plate, a showerhead 230, gas lines, a nozzle, a lid, a liner, a liner kit, a shield, a plasma screen, a flow equalizer, a cooling base, a chamber viewport, a chamber lid, and so on. The chamber components may be composed of metals, metal alloys, ceramics, and any combination thereof. The chamber components may include coatings, such as plasma resistant or corrosion resistant coatings. The coatings may be coatings deposited or grown via atomic layer deposition, plasma spray coating, chemical vapor deposition, ion-assisted deposition, sputtering, physical vapor deposition, electroplating, anodization, and so on.

In one embodiment, the processing chamber 200 includes a chamber body 202 and a showerhead 230 that enclose an interior volume 206. The showerhead 230 may include a showerhead base and a showerhead gas distribution plate. Alternatively, the showerhead 230 may be replaced by a lid and a nozzle in some embodiments. The chamber body 202 may be fabricated from aluminum, stainless steel or other suitable material. The chamber body 202 generally includes sidewalls 208 and a bottom 210. Any of the showerhead 230 (or lid and/or nozzle), sidewalls 208 and/or bottom 210 may include a coating. In some embodiments, the showerhead 230 (or lid and/or nozzle) may be removed so that a sensor fixture (e.g., sensor fixture 110 of FIG. 1) can be coupled to the chamber body 202 for generating distance measurements with respect to the substrate support 248.

An outer liner 216 may be disposed adjacent the sidewalls 208 to protect the chamber body 202. In one embodiment, the outer liner 216 is fabricated from aluminum oxide.

An exhaust port 226 may be defined in the chamber body 202, and may couple the interior volume 206 to a pump system 228. The pump system 228 may include one or more pumps and throttle valves utilized to evacuate and regulate the pressure of the interior volume 206 of the processing chamber 200.

The showerhead 230 may be supported on the sidewall 208 and/or top of the chamber body 202. The showerhead 230 (or lid) may be opened to allow access to the interior volume 206 of the processing chamber 200 in some embodiments, and may provide a seal for the processing chamber 200 while closed. A gas panel 258 may be coupled to the processing chamber 200 to provide process and/or cleaning gases to the interior volume 206 through the showerhead 230 or lid and nozzle. Showerhead 230 is used for processing chambers used for dielectric etch (etching of dielectric materials). The showerhead 230 may include a gas distribution plate (GDP) having multiple gas delivery holes 232 throughout the GDP. The showerhead 230 may include the GDP bonded to an aluminum showerhead base or an anodized aluminum showerhead base. The GDP 233 may be made from Si or SiC, or may be a ceramic such as Y₂O₃, Al₂O₃, YAG, and so forth. Showerhead 230 and delivery holes 232 may be characterized using system 100 or 150 in embodiments. For processing chambers used for conductor etch (etching of conductive materials), a lid may be used rather than a showerhead. The lid may include a center nozzle that fits into a center hole of the lid. The lid may be a ceramic such as Al₂O₃, Y₂O₃, YAG, or a ceramic compound comprising Y₄Al₂O₉ and a solid-solution of Y₂O₃—ZrO₂. The nozzle may also be a ceramic, such as Y₂O₃, YAG, or the ceramic compound comprising Y₄Al₂O₉ and a solid-solution of Y₂O₃—ZrO₂.

The substrate support assembly 248 is disposed in the interior volume 206 of the processing chamber 200 below the showerhead 230 or lid. The substrate support assembly 248 holds the substrate 244 during processing and may include an electrostatic chuck bonded to a cooling plate. In some embodiments, the substrate support assembly 248 includes a platform that supports the substrate 244. In some embodiments, the substrate support assembly 248 includes a ring that substantially surrounds the periphery of the substrate 244. In some embodiments, the substrate support assembly substantially surrounds the periphery of the substrate 244 but does not support the substrate 244. In some embodiments, the properties of the substrate support assembly 248 (e.g., such as surface finish properties and/or alignment properties, etc.) can be determined based on generated distance measurements as described herein. The properties for each of the embodiments described above (e.g., where the substrate support assembly 248 includes a platform and/or a ring, etc.) can be determined based on generated distance measurements as described herein.

In some embodiments, the substrate support assembly 248 is rotatable (e.g., by a first actuator that rotates the substrate support assembly 248 about a vertical axis of a shaft of the substrate support assembly 248). In some embodiments, the substrate support assembly is movable in a z-direction (e.g., vertically), such as by an additional actuator (e.g., a linear actuator). The substrate support 248 may be both rotatable to increase a uniformity of processed substrates, and may be movable in the vertical direction to control a distance between the substrate and the showerhead 230 in embodiments.

In embodiments, the showerhead or lid may be removed before or between uses of the process chamber to perform one or more manufacturing, testing and/or maintenance operations on the process chamber. A calibration fixture or measurement fixture (not shown in FIG. 2) may be positioned on the top of the process chamber in place of the lid or showerhead. A plurality of measurements may be generated of the substrate support as described in greater detail below to characterize one or more properties of the substrate support. A method of substrate support assessment and/or calibration may be performed using distance measurements generated by the calibration fixture in embodiments. The method may be performed, for example, after manufacturing of the process chamber and before shipment to a customer. Additionally, or alternatively, the method may be performed at a fabrication on a used process chamber (e.g., to determine whether the substrate support has become worn and/or should be replaced).

An inner liner may be on the periphery of the substrate support assembly 248. The inner liner may be a halogen-containing gas resist material such as those discussed with reference to the outer liner 216. In one embodiment, the inner liner 218 may be fabricated from the same materials of the outer liner 216.

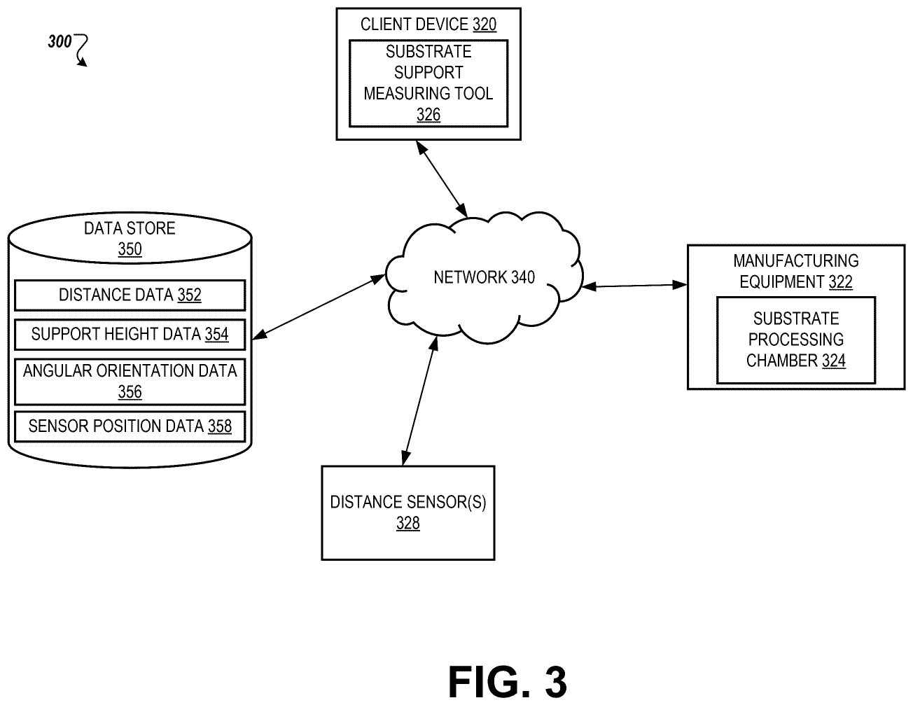

FIG. 3 depicts an illustrative computer system architecture 300, according to aspects of the present disclosure. Computer system architecture 300 includes a client device 320, manufacturing equipment 322, distance sensors 328, and a data store 350. In some embodiments, computer system architecture 300 can include or be a part of a manufacturing system for processing substrates, or substrate support measuring tool 326.

Components of the client device 320, manufacturing equipment 322, distance sensors 328, and/or data store 350 can be coupled to each other via a network 340. In some embodiments, network 340 is a public network that provides client device 320 with access to distance sensors 328, manufacturing equipment 322, data store 350, and other publicly available computing devices. In some embodiments, network 340 is a private network that provides client device 320 access to manufacturing equipment 322, distance sensors 328, data store 350, and/or other privately available computing devices. Network 340 can include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

The client device 320 can include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. A substrate support measuring tool 326 may be executed on the client device 320, such as for determining properties associated with the surface and/or alignment of a substrate support.

Manufacturing equipment 322 can produce products following a recipe. In some embodiments, manufacturing equipment 322 can include or be a part of a manufacturing system that includes one or more stations (e.g., process chambers, transfer chamber, load lock, factory interface, etc.) configured to perform different operations for a substrate. Manufacturing equipment 322 may include a substrate processing chamber 324 having a substrate support disposed therein.

Distance sensors 328 may be sensors for generating distance measurements with respect to a substrate support (e.g., disposed within substrate processing chamber 324). Distance sensors 328 may provide sensor data (e.g., distance data, etc.) to the client device 320 for determination of substrate support properties (e.g., alignment properties, surface properties, etc.) by the substrate support measuring tool 326. The distance sensors 328 may generate distance data 352 (e.g., of distances between distance sensors 328 of a calibration fixture mounted to a process chamber and locations on a substrate support), which can be stored in the data store 350.

The substrate support measuring tool 326 may process the distance measurements generated by distance sensors 328 to determine metric values to quantify the substrate support properties, as discussed in greater detail below. The substrate support measuring tool 326 may determine the metric values based on the distance data 352, the support height data 354, the angular orientation data 356, and/or the sensor position data 358. The distance data 352 may be indicative of a plurality of distance measurements of the distance between the distance sensors 328 and the top surface of the substrate support. The support height data 354 may be indicative of the vertical position of the substrate support when the distance measurements were generated. The angular orientation data 356 may be indicative of the angular orientation of the substrate support when the distance measurements were generated. The sensor position data 358 may be indicative of the position of the distance sensors 328 when the distance measurements were generated.

In some embodiments, the substrate support measuring tool 326 determines the metric values by aggregating and/or normalizing one or more measurements into a unitless value that is indicative of the one or more measurements. In some embodiments, a metric value is determined for each alignment property, such as substrate support tilt, substrates support shaft tilt, substrate support flatness, and/or substrate support misalignment, etc. In some embodiments, a metric value is determined for each surface property, such as substrate support surface roughness and/or substrate support surface flatness, etc.

Data store 350 can be a memory (e.g., random access memory), a drive (e.g., a hard drive, a flash drive), a database system, or another type of component or device capable of storing data. Data store 350 can include multiple storage components (e.g., multiple drives or multiple databases) that can span multiple computing devices (e.g., multiple server computers). The data store 350 can store emissivity data and surface roughness data (e.g., generated by optical measuring tool 326).

One or more portions of data store 350 can be configured to store data that is not accessible to a user of the manufacturing system. In some embodiments, all data stored at data store 350 can be inaccessible by the manufacturing system user. In other or similar embodiments, a portion of data stored at data store 350 is inaccessible by the user while another portion of data stored at data store 350 is accessible to the user. In some embodiments, inaccessible data stored at data store 350 is encrypted using an encryption mechanism that is unknown to the user (e.g., data is encrypted using a private encryption key). In other or similar embodiments, data store 350 can include multiple data stores where data that is inaccessible to the user is stored in a first data store and data that is accessible to the user is stored in a second data store.

FIG. 4 illustrates various substrate support assembly alignment properties 400, according to aspects of the present disclosure. In some embodiments, the substrate support 120 is misaligned with respect to a reference plane 410. The reference frame may be a reference frame of the process chamber in which the substrate support is mounted in some embodiments. The reference plane 410 at least partially forms an inertial reference frame in embodiments. A vertical axis 420 (e.g., a vertical axis of the center of the substrate support 120) may be orthogonal to the reference plane 410 and may at least partially form the inertial reference frame. In some embodiments, the inertial reference frame corresponds to the interior of the substrate processing chamber. An exaggerated misalignment of the substrate support 120 is shown for illustrative purposes.

An axis 422 (e.g., a first axis) of the substrate support 120 may be orthogonal to the top surface of the substrate support. An axis 424 (e.g., a second axis) of the substrate support shaft may be parallel to the shaft and may correspond to the central axis of the shaft about which the substrate support may rotate. In some embodiments, one of the determined alignment properties includes an orientation of the axis 422 relative to the axis 424. The difference in orientation of the axis 422 and the axis 424 is indicative of the inclination (e.g., tilt, wobble, etc.) of the substrate support 120 on the substrate support shaft. In some embodiments, as the substrate support 120 is rotated during measurement (e.g., using distance sensors as described herein), the distance between the top surface of the substrate support 120 and the distance sensor fluctuates. Periodic fluctuation in distance between the top surface and the distance sensor may correspond to the inclination of the substrate support 120 on the support shaft when the period of the fluctuation corresponds to a full rotation of the substrate support 120.

An axis 414 (e.g., a third axis) of the reference plane 410 may be orthogonal to the reference plane 410. In some embodiments, one of the determined alignment properties includes an inclination of the axis 424 relative to the axis 414. The inclination of the axis 424 relative to the axis 414 is indicative of the inclination of the substrate support shaft with respect to the inertial reference frame. In some embodiments, the inclination of the axis 424 relative to the axis 414 is determined using distance measurements generated while the substrate support 120 is at the first height and the second height. For example, as described below, the horizontal position of the center of the substrate support 120 may be determined when the substrate support 120 is at the first height and when the substrate support 120 is at the second height. Geometric principles (e.g., geometric calculations, etc.) may be used to determine the inclination of the support shaft relative to the reference frame axis 424 based on the difference in horizontal position.

An axis 412 (e.g., a fourth axis) of a distance sensor may be parallel to a beam emitted by the distance sensor while distance measurements are generated. In some embodiments, one of the determined alignment properties includes an orientation of axis 412 relative to the axis 422. In some embodiments, multiple distance sensors each emit a beam to generate distance measurements. Each of the emitted beams has an associated axis 412. The orientation of each of the axes 412 (e.g., corresponding to each of the distance sensors) relative to the axis 422 may be determined.

In some embodiments, one of the determined alignment properties includes a distance 416 from the axis 414 to a center of the substrate support 120. The distance 416 may be indicative of a misalignment of the center of the substrate support 120 relative to the axis 414. The center of the substrate support 120 may correspond to axis 420. The distance 416 is indicative of the horizontal alignment of the substrate support 120 with respect to the center of the inertial reference frame. In some embodiments, the distance 416 can be quantified by correlating the distance measurements generated by two or more distance sensors during the rotation of the substrate support 120. The difference in horizontal position may be related to the inclination of the axis 424 relative to the axis 414. The computation of the difference in horizontal position may be used to determine the inclination of the axis 424 relative to the axis 414. In some embodiments, the difference in horizontal position is determined based on the correlation of distance measurements from two or more distance sensors when the substrate support is at the first measuring height and when the substrate support is at the second measuring height.

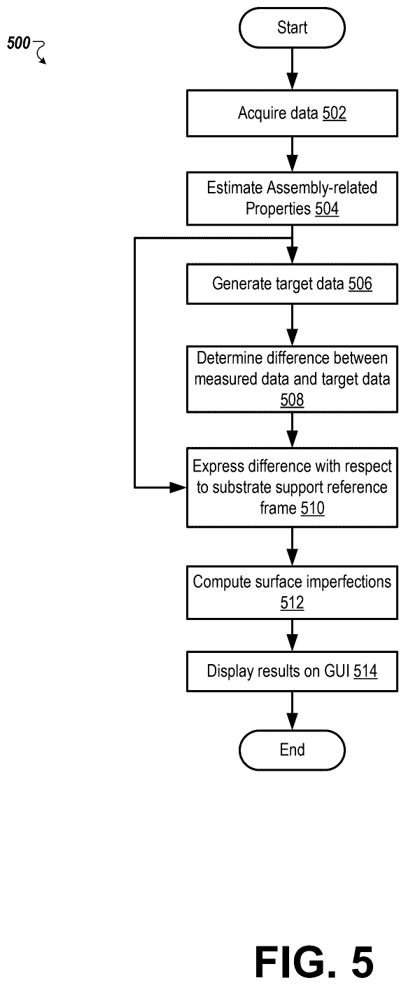

FIG. 5 is a flow chart of a method 500 for determining substrate support properties, according to aspects of the present disclosure. Method 500 may be performed by processing logic that can include hardware (circuitry, dedicated logic, etc.), software (such as is run on a general purpose computer system or a dedicated machine), firmware, or some combination thereof. In one implementation, method 500 can be performed by a computer system, such as computer system architecture 300 of FIG. 3. In other or similar implementations, one or more operations of method 500 can be performed by one or more other machines not depicted in the figures.

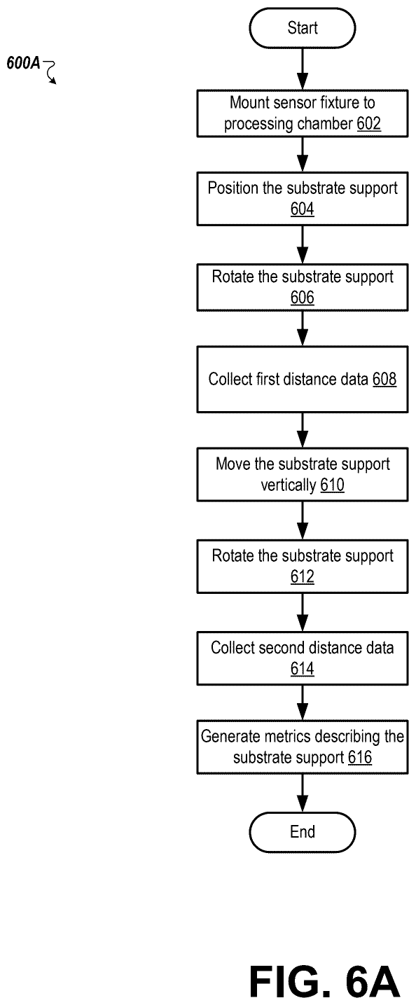

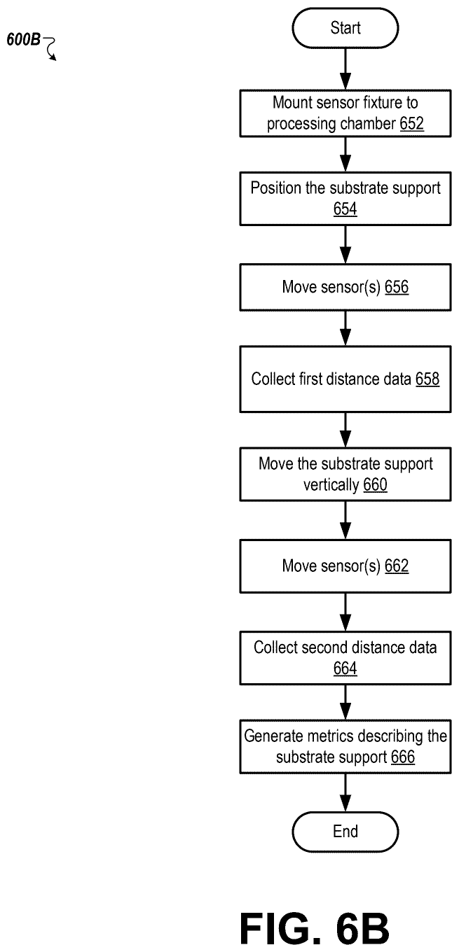

At block 502, data is acquired. Acquired data may include distance measurement data, angular orientation measurement data, height measurement data, and/or position measurement data. Acquisition of distance measurement data may be described in more detail herein with respect to FIGS. 6A-6B. In embodiments, distance measurement data is acquired for a plurality of locations on a substrate support. For example, the substrate support may be rotated, and measurements may be taken of a plurality of locations at one or more radial distances from a center of the substrate support during the rotation. Such measurements may be generated at multiple different vertical positions of the substrate support in embodiments.

At block 504, assembly-related properties are estimated. Assembly-related properties may include alignment properties, such as properties associated with an alignment of a substrate support, such as the properties described herein above with respect to FIG. 4. In some embodiments, the assembly-related properties are estimated based on the sensor data acquired at block 502. For example, estimation of the substrate support alignment properties are determined based on the acquired sensor data.

At block 506, target data is determined by solving multiple optimization problems, each setup with a subset of the total acquired data (e.g., acquired at block 502). The target data may include a set of target distance measurements. In some embodiments, the set of target distance measurements corresponds to a virtual substrate support having an idealized condition. For example, and in some embodiments, a set of target distance measurements is generated corresponding to a flat virtual substrate.

At block 508, the difference between the measured data and the target data is determined. For example, the difference between the actual distance measurements and the target distance measurements may determined. The actual distance measurements may be subtracted from the corresponding target distance measurements to determine a net difference between the measurements.

At block 510, the difference (e.g., determined at block 508) is expressed with respect to the substrate support reference frame. For example, using the substrate support as a reference frame (e.g., and not the inertial reference plane, inertial reference axis, etc.), the difference between the actual distance measurement data and target distance measurement data is expressed with respect to the substrate support reference frame. Doing so allows quantification of the defects of the surface of the substrate support.

At block 512, the surface imperfections of the substrate support are computed. The surface imperfections may include a surface roughness and/or a surface flatness of the top surface of the substrate support. The surface roughness and/or surface flatness may be determined based on the data acquired at block 502. For example, and in some embodiments, the distance measurements acquired at block 502 include variations in distance. High frequency variations in the measurements may be indicative of the surface roughness while low frequency variations in the measurements may be indicative of surface flatness. The variations can therefore be used to determine one or more metrics indicative of surface roughness and/or surface flatness.

At block 514, the results are displayed on a GUI. In some embodiments, one or more metric values indicative of the results are displayed on the GUI. One or more corrective actions associated with the substrate support may be performed based on the one or more metric values. In some embodiments, a corrective action may include outputting a recommendation to replace the substrate support and/or to perform maintenance on the substrate support. In some embodiments, a corrective action may include automatically scheduling maintenance of the substrate support responsive to determining that such maintenance is warranted.

FIGS. 6A-6B are flow charts of methods 600A and 600B for collecting data associated with a substrate support, according to aspects of the present disclosure. Methods 600A and 600B is performed by a system that can include hardware (circuitry, dedicated logic, substrate support measuring tools as described herein, etc.), software (such as is run on a general purpose computer system or a dedicated machine), firmware, or some combination thereof. In one implementation, methods 600A and 600B can be performed by a computer system, such as computer system architecture 300 of FIG. 3 In other or similar implementations, one or more operations of method 600 can be performed by one or more other machines or users not depicted in the figures (e.g., such as an engineer or technician, etc.).

Referring to FIG. 6A, at block 602, a sensor fixture is mounted to a processing chamber. The sensor fixture may include one or more distance sensors configured to measure the distance between the distance sensors and the top surface of a substrate support. When the sensor fixture is mounted to the processing chamber, the distance sensors are disposed above the substrate support.

At block 604, the substrate support is positioned for measuring. For example, and in some embodiments, the substrate support is positioned vertically at a first height within the processing chamber.

At block 606, the substrate support is rotated. An angular orientation sensor may generate angular orientation measurement data indicative of the angular orientation of the substrate support as the substrate support is rotated.

At block 608, first distance data is collected. The first distance data may include sensor data indicative of a first plurality of distance measurements of the substrate support at the first height. The first plurality of distance measurements may be generated while the substrate support is rotated. Each distance measurement may be associated with an angular orientation of the substrate support, and thus may be a measurement of a particular location on the substrate support associated with the angular orientation. Each distance measurement may additionally be associated with a vertical position setting of the substrate support, and so may be a measurement of a distance for a particular location on the substrate support at a particular vertical position setting.

At block 610, the substrate support is moved vertically from the first height to a second height. The second height may be higher or lower than the first height. The first height and/or the second height may be predetermined. A vertical position sensor (e.g., an optical encoder) may measure the first height and/or the second height of the substrate support.

At block 612, the substrate support is rotated. The angular orientation sensor may generate angular orientation measurement data indicative of the angular orientation of the substrate support.

At block 614, second distance data is collected. The second distance data may include sensor data indicative of a second plurality of distance measurements of the substrate support at the second height. The second plurality of distance measurements may be generated while the substrate support is rotated.

At block 616, metric values describing the substrate support are generated. One or more metric values may be unitless values indicative of the substrate support surface properties and/or indicative of the substrate support alignment properties as described herein. One or more metric values may include units. One or more measured property values may be aggregated and/or normalized to transform the measured property values into metric values. The metric values may therefore be indicative of the measured property values.

Referring to FIG. 6B, at block 652, a sensor fixture is mounted to a processing chamber. The sensor fixture may include one or more distance sensors configured to measure the distance between the distance sensors and the top surface of a substrate support. When the sensor fixture is mounted to the processing chamber, the distance sensors are disposed above the substrate support. The one or more sensors may be movable relative to the sensor fixture. For example, a sensor may be coupled to a track on the sensor fixture and may be movable along the track. A position sensor may generate position measurements of one or more positions of the distance sensor on the sensor fixture.

At block 654, the substrate support is positioned for measuring. For example, and in some embodiments, the substrate support is positioned vertically at a first height within the processing chamber.

At block 656, one or more of the distance sensors are moved relative to the sensor fixture. A distance sensor may be moved to generate distance measurements with respect to multiple locations on the top surface of the substrate support. The position sensor may generate position measurement data indicative of the position of the moved distance sensor.

At block 668, first distance data is collected. The first distance data may include sensor data indicative of a first plurality of distance measurements of the substrate support at the first height. The first plurality of distance measurements may be generated while the one or more distance sensors are moved.

At block 660, the substrate support is moved vertically from the first height to a second height. The second height may be higher or lower than the first height. The first height and/or the second height may be predetermined. A vertical position sensor may measure the first height and/or the second height of the substrate support.

At block 662, one or more of the distance sensors are moved relative to the sensor fixture. The position sensor may generate position measurement data indicative of the position of the moved distance sensor.

At block 664, second distance data is collected. The second distance data may include sensor data indicative of a second plurality of distance measurements of the substrate support at the second height. The second plurality of distance measurements may be generated while the one or more distance sensors are moved.

At block 666, metric values describing the substrate support are generated. The metric values may be unitless values indicative of the substrate support surface properties and/or indicative of the substrate support alignment properties as described herein.

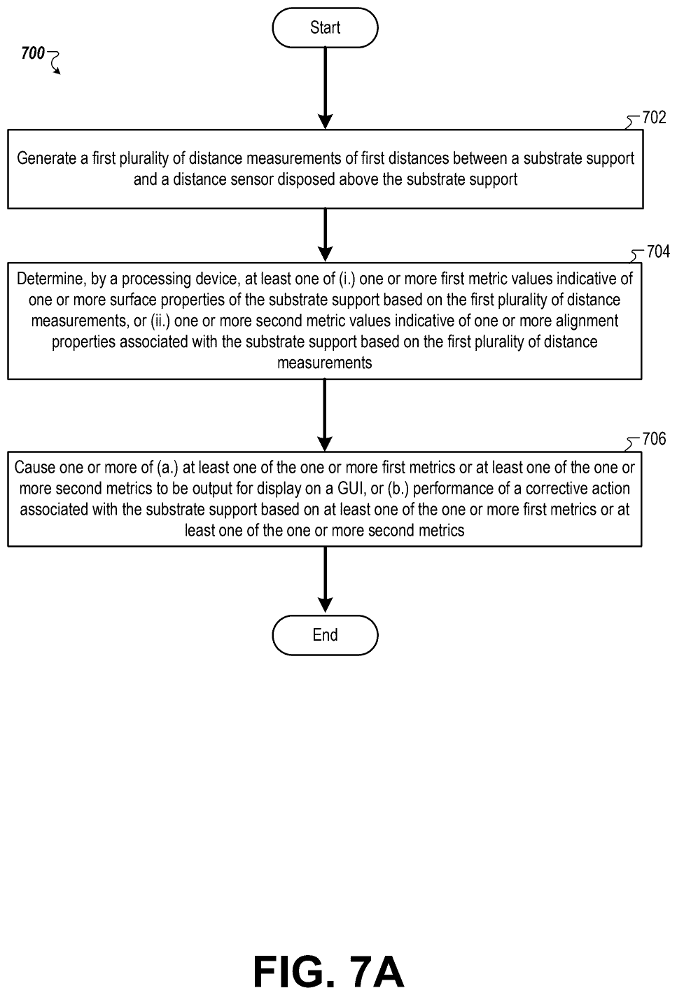

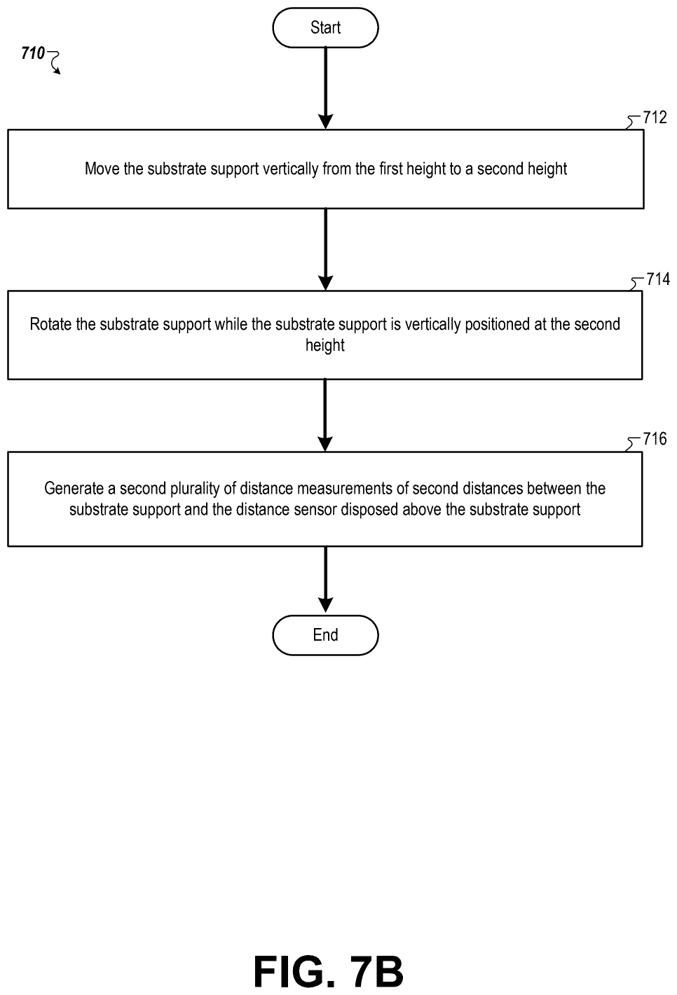

FIGS. 7A-7B are flow charts of methods 700 and 710 for determining substrate support properties, according to aspects of the present disclosure. Methods 700 and 710 may be performed by processing logic that can include hardware (circuitry, dedicated logic, etc.), software (such as is run on a general purpose computer system or a dedicated machine), firmware, or some combination thereof. In one implementation, methods 700 and 710 can be performed by a computer system, such as computer system architecture 300 of FIG. 3. In other or similar implementations, one or more operations of methods 700 and 710 can be performed by one or more other machines not depicted in the figures. In some embodiments, method 710 can be performed in conjunction with method 700.

Referring to FIG. 7A, a flow chart of method 700 is shown. At block 702, a first plurality of distance measurements of first distances between a substrate support and a distance sensor disposed above the substrate support are generated. In some embodiments, the first plurality of distance measurements are generated by a distance sensor coupled to a sensor fixture. The sensor fixture may be coupled to a processing chamber having the substrate support disposed therein. The first plurality of distance measurements may be generated while the substrate support is vertically positioned (e.g., within the processing chamber) at a first height. In some embodiments, the substrate support is rotated while vertically positioned at the first height while the first plurality of distance measurements are generated. An angular orientation sensor may generate angular orientation measurements of the angular orientation of the substrate support while the substrate support is rotated.

At block 704, a processing device determines at least one of (i.) one or more first metric values indicative of one or more surface properties of the substrate support based on the first plurality of distance measurements, or (ii.) one or more second metric values indicative of one or more alignment properties associated with the substrate support based on the first plurality of distance measurements. In some embodiments, the one or more first metric values and/or the one or more second metric values are determined further based on the angular orientation measurements generated by the angular orientation sensor. The one or more first metric values may be unitless values that quantify the one or more surface properties. The one or more second metric values may be unitless values that quantify the one or more alignment properties. The one or more surface properties may include a surface roughness of the top surface of the substrate support and/or a surface flatness of the top surface of the substrate support. The one or more alignment properties may include an orientation of an axis of the substrate support relative to an axis of a shaft associated with the substrate support, an inclination of the shaft axis relative to an axis of an inertial reference frame, an orientation of an axis associated with distance sensor relative to the axis of the substrate support, and/or a misalignment of the axis of the inertial reference frame relative to the substrate support. More details regarding the alignment properties are discussed herein above with respect to FIG. 4. Each of the individual properties may be assigned a metric values. For example, one metric value may correspond to surface roughness while another metric value may correspond to surface flatness.

At block 706, the processing device causes one or more of (a.) at least one of the one or more first metric values or at least one of the one or more second metric values to be output for display on a GUI, or (b.) performance of a corrective action associated with the substrate support based on at least one of the one or more first metric values or at least one of the one or more second metric values. The one or more first metric values and/or the one or more second metric values may be output for display on the GUI for viewing, such as by a technician or engineer, etc. The technician or engineer may make a determination of the state of the substrate support based on the output metric values. In some embodiments, the processing device assesses the determined metric values, such as by comparing the determined metric values to one or more rules or criteria, etc. If the determined metric values violate the one or more criteria, a corrective action may be performed. In some embodiments, the corrective action includes outputting an indication associated with the state of the substrate support, such as that the substrate support does not meet the one or more rules or criteria. In some embodiments, the one or more rules or criteria include a threshold surface condition and/or a threshold alignment condition. In some embodiments, the corrective action includes initiating a maintenance procedure associated with the substrate support. For example, the corrective action can include outputting an indication that the substrate support is to be rebuilt, re-aligned, and/or replaced, etc. so that the substrate support can meet a threshold surface condition and/or a threshold alignment condition. In some embodiments, the processing device may schedule maintenance of the substrate support responsive to determining that such maintenance is warranted.

Referring to FIG. 7B, method 710 is shown. Method 710 may be performed in conjunction with method 700. At block 712, the substrate support is moved vertically from the first height to a second height. The second height may be higher or lower than the first height. A height position sensor may generate one or more height position measurements of the substrate support. In some embodiments, the first height and/or the second height are predetermined.

At block 714, the substrate support is rotated while the substrate support is vertically positioned at the second height. The angular orientation sensor may generate angular orientation measurements of the angular orientation of the substrate support while the substrate support is rotated.

At block 716, a second plurality of distance measurements of second distances between the substrate support and the distance sensor disposed above the substrate support are generated. The one or more first metric values and/or the one or more second metric values may be determined further based on the second plurality of distance measurements.

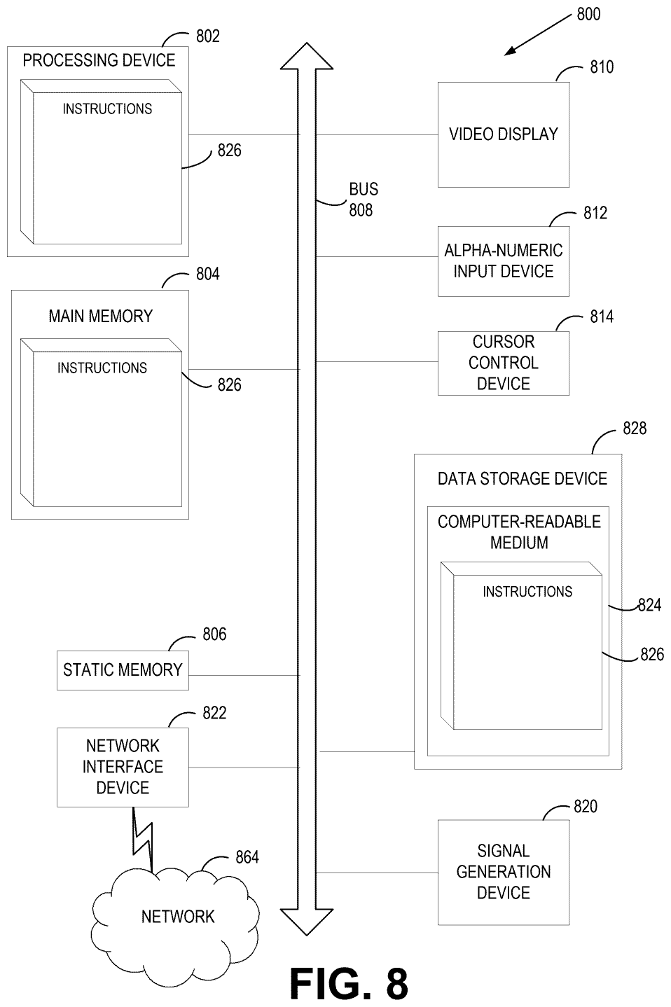

FIG. 8 depicts a diagrammatic representation of a computing device 800, according to aspects of the present disclosure. depicts a diagrammatic representation of a machine in the example form of a computing device 800 within which a set of instructions, for causing the machine to perform any one or more of the methodologies discussed herein, can be executed. In alternative embodiments, the machine can be connected (e.g., networked) to other machines in a Local Area Network (LAN), an intranet, an extranet, or the Internet. The machine can operate in the capacity of a server or a client machine in a client-server network environment, or as a peer machine in a peer-to-peer (or distributed) network environment. The machine can be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein. In embodiments, computing device 800 can correspond to architecture 300 as described herein.

The example computing device 800 includes a processing device 802, a main memory 804 (e.g., read-only memory (ROM), flash memory, dynamic random access memory (DRAM) such as synchronous DRAM (SDRAM), etc.), a static memory 806 (e.g., flash memory, static random access memory (SRAM), etc.), and a secondary memory (e.g., a data storage device 828), which communicate with each other via a bus 808.

Processing device 802 can represent one or more general-purpose processors such as a microprocessor, central processing unit, or the like. More particularly, the processing device 802 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. Processing device 802 can also be or include a system on a chip (SoC), programmable logic controller (PLC), or other type of processing device. Processing device 802 is configured to execute the processing logic for performing operations discussed herein.

The computing device 800 can further include a network interface device 822 for communicating with a network 864. The computing device 800 also can include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 820 (e.g., a speaker).

The data storage device 828 can include a machine-readable storage medium (or more specifically a non-transitory computer-readable storage medium) 824 on which is stored one or more sets of instructions 826 embodying any one or more of the methodologies or functions described herein. A non-transitory storage medium refers to a storage medium other than a carrier wave. The instructions 826 can also reside, completely or at least partially, within the main memory 804 and/or within the processing device 802 during execution thereof by the computer device 800, the main memory 804 and the processing device 802 also constituting computer-readable storage media.

While the computer-readable storage medium 824 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure can be practiced without these specific details. In other instances, well-known components or methods are not described in detail or are presented in simple block diagram format in order to avoid unnecessarily obscuring the present disclosure. Thus, the specific details set forth are merely exemplary. Particular implementations can vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within +10%.

Although the operations of the methods herein are shown and described in a particular order, the order of operations of each method can be altered so that certain operations can be performed in an inverse order so that certain operations can be performed, at least in part, concurrently with other operations. In another embodiment, instructions or sub-operations of distinct operations can be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
generating a first plurality of distance measurements of first distances between a substrate support and one or more distance sensors disposed above the substrate support;
determining, by a processing device, at least one of (i.) one or more first metric values indicative of one or more surface properties of the substrate support based on the first plurality of distance measurements, or (ii.) one or more second metric values indicative of one or more alignment properties associated with the substrate support based on the first plurality of distance measurements; and
causing, by the processing device, one or more of (a.) at least one of the one or more first metric values or at least one of the one or more second metric values to be output for display on a graphical user interface (GUI), or (b.) performance of a corrective action associated with the substrate support based on at least one of the one or more first metric values or at least one of the one or more second metric values.

2. The method of claim 1, further comprising:
rotating the substrate support while the substrate support is vertically positioned at a first height while the first plurality of distance measurements are generated.

3. The method of claim 2, further comprising:
moving the substrate support vertically from the first height to a second height;
rotating the substrate support while the substrate support is vertically positioned at the second height; and
generating a second plurality of distance measurements of second distances between the substrate support and the one or more distance sensors disposed above the substrate support, wherein at least one of the one or more first metric values or the one or more second metric values are determined further based on the second plurality of distance measurements.

4. The method of claim 2, further comprising:
generating a plurality of orientation measurements of one or more angular orientations of the substrate support, wherein at least one of the one or more first metric values or the one or more second metric values are determined further based on the plurality of orientation measurements.

5. The method of claim 1, wherein the one or more alignment properties comprise at least one of:
a first orientation of a first axis of the substrate support relative to a second axis of a shaft associated with the substrate support;
an inclination of the second axis relative to a third axis of an inertial reference frame;
a second orientation of a fourth axis associated with the one or more distance sensors relative to the first axis; or
a misalignment of the third axis relative to a center of the substrate support.

6. The method of claim 1, wherein the one or more surface properties comprise at least one of a surface roughness or a surface flatness.

7. The method of claim 1, further comprising:
determining, by the processing device, a difference between the first plurality of distance measurements and a set of target distance measurements, wherein at least one of the one or more first metric values or the one or more second metric values are determined based on the difference.

8. The method of claim 7, wherein the set of target distance measurements corresponds to a virtual substrate support having an idealized condition.

9. The method of claim 1, further comprising:
moving at least one of the one or more distance sensors relative to the substrate support; and
generating a plurality of position measurements of one or more positions of the at least one of the one or more distance sensors, wherein at least one of the one or more first metric values or the one or more second metric values are determined further based on the plurality of position measurements.

10. A non-transitory machine-readable storage medium comprising instructions that, when executed by a processing device, cause the processing device to perform operations comprising:
causing one or more distance sensors disposed above a substrate support to generate a first plurality of distance measurements of first distances between the substrate support and the one or more distance sensors;
determining at least one of (i.) one or more first metric values indicative of one or more surface properties of the substrate support based on the first plurality of distance measurements, or (ii.) one or more second metric values indicative of one or more alignment properties associated with the substrate support based on the first plurality of distance measurements; and
causing one or more of (a.) at least one of the one or more first metric values or at least one of the one or more second metric values to be output for display on a graphical user interface (GUI), or (b.) performance of a corrective action associated with the substrate support based on at least one of the one or more first metric values or at least one of the one or more second metric values.

11. The non-transitory machine-readable storage medium of claim 10, wherein the processing device is to perform operations further comprising:
cause the substrate support to rotate while the substrate support is vertically positioned at a first height while the first plurality of distance measurements are generated.

12. The non-transitory machine-readable storage medium of claim 11, wherein the processing device is to perform operations further comprising:
causing the substrate support to move vertically from the first height to a second height;
causing the substrate support to rotate while the substrate support is vertically positioned at the second height; and
causing the one or more distance sensors to generate a second plurality of distance measurements of second distances between the substrate support and the one or more distance sensors disposed above the substrate support, wherein at least one of the one or more first metric values or the one or more second metric values are determined further based on the second plurality of distance measurements.

13. The non-transitory machine-readable storage medium of claim 11, wherein the processing device is to perform operations further comprising:
causing an angular orientation sensor to generate a plurality of orientation measurements of one or more angular orientations of the substrate support, wherein at least one of the one or more first metric values or the one or more second metric values are determined further based on the plurality of orientation measurements.

14. The non-transitory machine-readable storage medium of claim 10, wherein the processing device is to perform operations further comprising:
determining a difference between the first plurality of distance measurements and a set of target distance measurements, wherein at least one of the one or more first metric values or the one or more second metric values are determined based on the difference, wherein the set of target distance measurements corresponds to a virtual substrate having an idealized condition.

15. The non-transitory machine-readable storage medium of claim 10, wherein the processing device is to perform operations further comprising:
causing at least one of the one or more distance sensors to move relative to the substrate support; and
causing a position sensor to generate a plurality of position measurements of one or more positions of the at least one of the one or more distance sensors, wherein at least one of the one or more first metric values or the one or more second metric values are determined further based on the plurality of position measurements.

16. A system, comprising:
a sensor fixture configured to couple to a substrate processing chamber;
one or more distance sensors coupled to the sensor fixture and configured to generate a first plurality of distance measurements of first distances between a substrate support disposed within the substrate processing chamber and the one or more distance sensors; and
a processing device operatively coupled to the one or more distance sensors, wherein the processing device is configured to:
determine at least one of (i.) one or more first metric values indicative of one or more surface properties of the substrate support based on the first plurality of distance measurements, or (ii.) one or more second metric values indicative of one or more alignment properties associated with the substrate support based on the first plurality of distance measurements; and
cause one or more of (a.) at least one of the one or more first metric values or at least one of the one or more second metric values to be output for display on a graphical user interface (GUI), or (b.) performance of a corrective action associated with the substrate support based on at least one of the one or more first metric values or at least one of the one or more second metric values.

17. The system of claim 16, wherein the substrate support is to rotate while vertically positioned at a first height while the first plurality of distance measurements are generated.

18. The system of claim 17, wherein the substrate support is to move vertically from the first height to a second height and rotate while vertically positioned at the second height, wherein the one or more distance sensors are further configured to generate a second plurality of distance measurements of second distances between the substrate support and the one or more distance sensors, wherein at least one of the one or more first metric values or the one or more second metric values are determined further based on the second plurality of distance measurements.

19. The system of claim 16, further comprising an angular orientation sensor configured to generate a plurality of orientation measurements of one or more angular orientations of the substrate support, wherein at least one of the one or more first metric values or the one or more second metric values are determined further based on the plurality of orientation measurements.

20. The system of claim 16, wherein at least one of the one or more distance sensors are movable relative to the sensor fixture, the system further comprising:
a position sensor configured to generate a plurality of position measurements of one or more positions of the at least one of the one or more distance sensors, wherein at least one of the one or more first metric values or the one or more second metric values are determined further based on the plurality of position measurements.
